(19) United States
(12) Patent Application Publication
(10) Pub. No.: US 2008/0006723 A1
(43) Pub. Date: Jan. 10, 2008

(54) Control Valve For An Injection Nozzle

(76) Inventors: Jaroslav Hlousek, Golling (AT); Franz Guggenbichler, Kuchl (AT)

Correspondence Address: FITCH, EVEN, TABIN & FLANNERY, P. O. BOX 18415, WASHINGTON, DC, 20036, US

(21) Appl. No.: 11/660,920

(22) PCT Filed: Aug. 18, 2005
(86) PCT No.: PCT/AT05/00331

§ 371 Date: Feb. 23, 2007

(30) Foreign Application Priority Data
Aug. 24, 2004 (AT) A 1426/2004

(51) Int. Cl. F02M 59/00

(52) U.S. Cl. 239/533.2

(57) ABSTRACT

In a control valve for an injection nozzle for injecting fuels into the combustion chamber of an internal combustion engine, including a nozzle needle (7) which is capable of being axially displaced in an injector nozzle (5) and reaches into a control chamber (12) feedable with a pressurized fuel whose pressure is controllable via the control valve (16), which opens or closes at least one inlet or outlet channel for fuel, the valve seat (19) of the valve (16) is arranged in a valve bush (23) separate from the valve body (3) and made of a wear-resistant material.

The invention relates to a control valve for an injection nozzle for injecting fuels into the combustion chamber of an internal combustion engine, including a nozzle needle which is capable of being axially displaced in an injector nozzle and reaches into a control chamber feedable with a pressurized fuel whose pressure is controllable via the control valve, which opens or closes at least one inlet or outlet channel for fuel.

Control valves of injectors for common-rail systems for injecting high-viscosity fuels into the combustion chamber of an internal combustion engine are known in various configurations. In the event of heavy oil, heating up to 150° C. is required to attain the necessary injection viscosity. A high portion of abrasively acting solids and a high temperature will naturally involve increased wear and, hence, affect the operating safety.

Basically, an injector for a common-rail injection system comprises different parts which, as a rule, are held together by a nozzle clamping nut. The injector nozzle proper includes a nozzle needle, which is guided within the nozzle body of the injector nozzle in an axially displaceable manner and has several clearance flanks through which fuel is able to flow from the nozzle prechamber to the tip of the needle. The nozzle needle itself carries a collar supporting a pressure spring and reaches into a control chamber capable of being fed with a pressurized fuel. To this control chamber can be connected an inlet channel via an inlet throttle and an outlet channel via an outlet throttle, the respective pressure built up within the control chamber together with the force of the pressure spring keeping the nozzle needle in the closed position. The pressure prevailing in the control chamber is controllable by a control valve, which in most cases is actuated by an electromagnet. If appropriate wiring is provided, the opening of the control valve will cause the drain of fuel via a throttle such that a reduction of the hydraulic holding force on the nozzle needle end face reaching into the control chamber will cause the opening of the nozzle needle. In this manner, fuel will subsequently be able to enter the combustion chamber of the motor through the injection openings.

In addition to an outlet throttle, an inlet throttle is also provided in most cases, wherein the opening speed of the nozzle needle is determined by the flow difference between inlet and outlet throttles. With the control valve closed, the outlet path of the fuel is blocked by the outlet throttle and pressure is newly built up in the control chamber via the inlet throttle, thus causing the closure of the nozzle needle.

The invention aims to provide a configuration of such a control valve, which will remain unsusceptible to failures even at high temperatures and also with highly viscous oils as well as a high portion of abrasively acting solids contained in the fuel and which will offer an enhanced reliability even under extreme conditions. To solve this object, the configuration is devised such that the valve seat of the valve is arranged in a valve bush separate from the valve body and made of a wear-resistant material. The use of a separate valve bush, wherein such a separate component, i.e. the valve bush, can be arranged in an accordingly cleared space of the valve body, will provide an easy exchange of such a valve bush and, if required, its replacement along with the respective valve needle during servicing work in the event of excessive wear on the valve seat.

In principle, the separate valve bush can be pressed into the valve body. In a particularly advantageous manner, the configuration is, however, devised such that said separate valve bush is floatingly mounted in a space of the valve body so as to offer a particularly easy exchangeability of possibly worn components.

A valve bush of this type allows for the arrangement of a number of additional control channels in the valve-bush-carrying valve body without this resulting in undesired material weaknesses. To this end, the configuration in a particularly advantageous manner is devised such that the valve bush on its cylindrical outer surfaces, or end faces, comprises grooves or chamfers forming channels leading to an outlet and/or inlet throttle for respectively letting fuel out of or into the control chamber, so as to enable a number of additional functions to be performed by the thus formed channels. The configuration in this respect may, for instance, be such that the valve needle carries grooves or flutes on its jacket, which cooperate with branch ducts leading to the jacket of the valve needle, wherein such branch ducts may serve cooling and lubrication by motor oil. Yet, it is likewise possible to conduct leakage fuel into a pressureless outlet channel.

In addition to a suitable material selection for the valve seat and the opportunity to readily exchange worn parts in the event of wear, the service life and, hence, the operating safety will in fact also be increased by providing appropriate cooling and flushing. In principle, any further fluid can be used for such cooling, yet with lubricating oil as is usually used also as motor oil being the preferred choice. The appropriate conduction of lubricant channels through the nozzle base body ensures basic cooling of the injector, whereby particularly exposed components such as, for instance, the valve needle guide within the valve body can be flushed in a particularly advantageous manner with such a coolant. As already pointed out above, the configuration to this end is advantageously devised such that a branch duct carrying lubricant oil and, in particular, motor oil opens on the valve needle cooperating with the valve seat. Such a lubricant oil conducted to the outer periphery of the valve needle renders feasible not only the cooling of the valve needle but, at the same time, by the appropriate configuration on the outer side of the valve needle, also the flushing of the valve needle guide within the valve body in order to remove possible deposits of impurities in the heavy oil. The motor oil used, thus, serves not only to cool sensitive components but, at the same time, also flush the valve needle in the valve body.

In the following, the invention will be explained in more detail by way of exemplary embodiments schematically illustrated in the drawing. Therein:

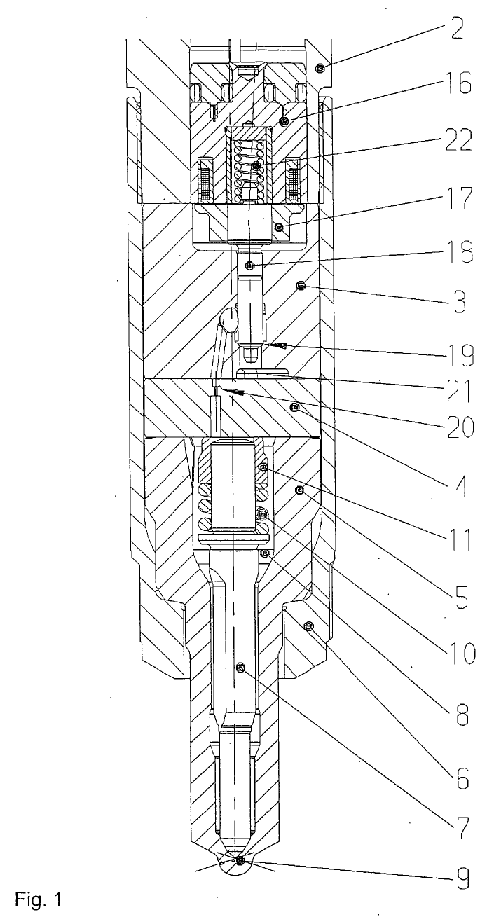

FIGS. 1 and 2 illustrate the basic structure of an injector according to the prior art;

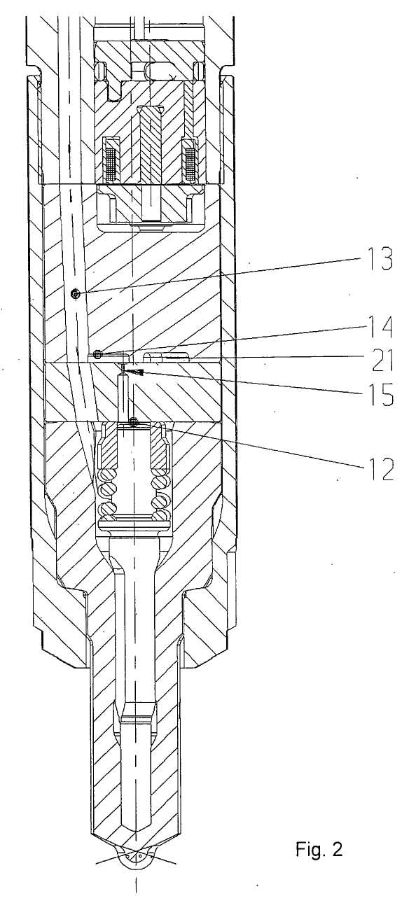

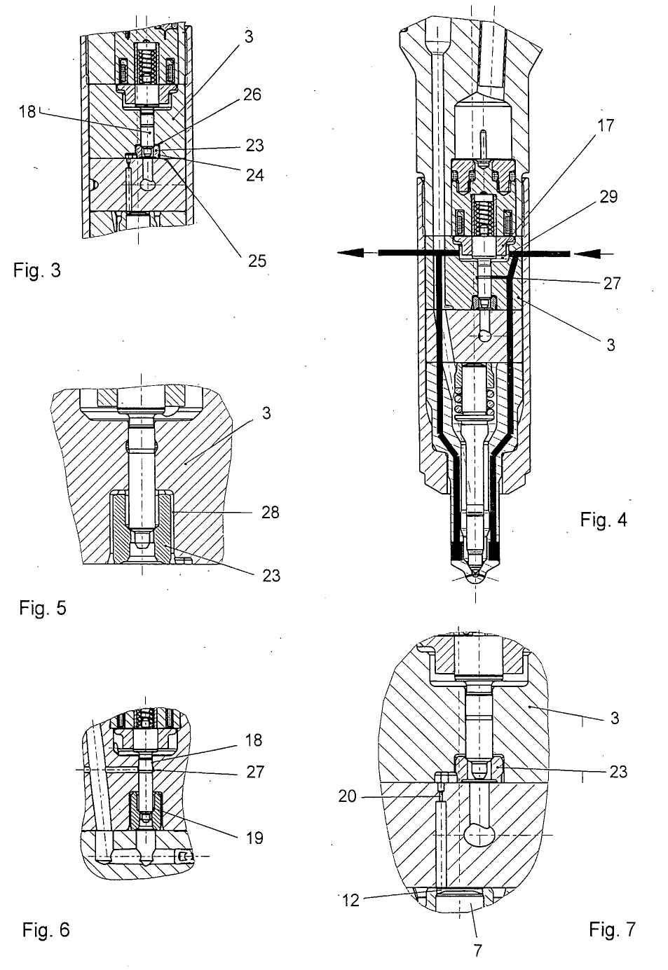

FIG. 3 is a section through a first configuration of the control valve according to the invention;

FIG. 4 illustrates the injector including a control valve according to the invention and channels for cooling the injector;

FIG. 5 depicts a section through the valve body with a pressed-in valve bush;

FIG. 6 is an enlarged illustration of the control valve as used in FIG. 4; and

FIG. 7 illustrates the configuration of a valve body comprising a floating valve bush for the control valve.

FIG. 1 depicts an injector 1 comprised an injector body 2, a valve body 3, an intermediate plate 4 and an injector nozzle 5. All these components are held together by a nozzle clamping nut 6. The injector nozzle 5 comprises a nozzle needle 7, which is guided in a longitudinally displaceable manner within the nozzle body of the injector nozzle 5 and has several clearance flanks through which fuel can flow from a nozzle prechamber 8 to the tip of the needle. During an opening movement of the nozzle needle 7, fuel is injected into the combustion chamber of the internal combustion engine through several injection openings 9.

The nozzle needle 7 comprises a collar on which a compression spring 10 is supported. The other end of the compression spring 10 is supported on a control sleeve 11, which in turn rests against the lower side of the intermediate plate 4. The control sleeve 11, by the upper end face of the nozzle needle 7 and the lower side of the intermediate plate 4, defines a control chamber 12. The pressure prevailing in the control chamber 12 is relevant for the control of the movement of the nozzle needle. Via a fuel inlet bore 13, which is apparent from FIG. 2, the fuel pressure, on the one hand, becomes effective in the nozzle prechamber 8, where it exerts a force in the opening direction of the nozzle needle 7 via the pressure shoulder of the nozzle needle 7. On the other hand, this fuel pressure acts in the control chamber 12 via an inlet channel 14 and an inlet throttle 15 as are illustrated in FIG. 2 and, assisted by the force of the pressure spring 10, holds the nozzle needle 7 in its closed position.

The subsequent activation of an electromagnet 16 will cause a magnet armature 17 and a valve needle 18 connected with the magnet armature 17 to be lifted and a valve seat 19 to be opened. The fuel from the control chamber 12 can, thus, flow off into a pressureless outlet channel 21 through an outlet throttle 20 and the open valve seat 19. The thus produced decrease of the hydraulic force exerted on the upper end face of the nozzle needle 7 causes the opening of the nozzle needle 7. In this manner, the fuel from the nozzle prechamber will reach the combustion chamber of the engine through the injection openings 9. With the injector nozzle 5 being in the opened state, high-pressure fuel flows into the control chamber 12 through the inlet throttle 15 and, at the same time, in a slightly larger amount, off through the outlet throttle 20. The so-called control amount is pressurelessly discharged into the outlet channel 21 and taken from the common rail in addition to the injected amount. The opening speed of the nozzle needle 7 is determined by the difference in the flow rates between the inlet throttle 15 and the outlet throttle 20.

As soon as the electromagnet 16 is shut off, the magnet armature 17 is pressed downwards by the force of a pressure spring 22 and the valve needle 18 is pressed at the valve seat 19. In this manner, the outlet path of the fuel is blocked by the outlet throttle 20. Via the inlet throttle 15, fuel pressure is again built up in the control chamber 12 and generates a closing force exceeding the hydraulic force exerted on the pressure shoulder of the nozzle needle 7, reduced by the force of the pressure spring 10. The nozzle needle 7 closes the path to the injection openings 9, thus concluding the injection procedure.

The injector configuration represented in FIGS. 1 and 2 is basically suitable for low-viscosity fuels. With highly viscous fuels, preheating is required, for which fuel heating temperatures of up to 150° C. are necessary. Moreover, highly viscous fuels in most cases also contain higher portions of impurities, whereby, in addition to the required fuel heating, heating of the magnetic valve by the control current will result in excessive heating of, and possible damage to, this component. Fuel impurities would cause jamming of the valve needle after a short time, which would lead to an excessive wear of the valve needle and the valve seat.

In order to overcome this drawback, the control valve configuration according to the invention illustrated in FIG. 3 was created. The valve seat in this case is arranged in a valve bush 23 provided within a cylindrically cleared space 24 of the valve body 3. The valve bush 23, in this case, can either be pressed into the valve body 3 as will be explained in more detail below with reference to FIG. 5 or floatingly guided between the surface 25 provided in the valve body 3 to upwardly delimit the space 24 and the upper end face of the intermediate place 4. In the latter case, centering is effected by the aid of a cone 26 provided on the lower end of the valve needle 18. This cone 26 is pressed on the valve seat in the valve bush 23, with the floating valve bush 23 being permanently held in contact with the intermediate plate even in the opened state of the valve due to the hydraulic forces acting on it. The valve bush 23 can be made of a particularly wear-resistant hard metal, whereby a cost-effective replacement together with the valve needle 18 will be feasible, if excessive wear is detected on the valve seat 19 of the valve bush 23.

As already mentioned, internal combustion engines operated with heavy oil require heating of the fuel, which will impose additional heating loads on common-rail injectors. In addition to the fuel already preheated up to 150° C. to lower its viscosity, the nozzle tip projecting into the combustion chamber will be heated by the hot combustion gases. Further heating will also be caused by the control current for the magnetic valve. As is apparent from FIG. 4, cooling is provided in this case in a particularly advantageous manner by the injector being constantly flushed with motor oil. The flushing channels provided in the injector are entered in black in FIG. 4, the motor oil via these channels reaching the region of the nozzle tip and a chamber 29 of the valve body 3, in which the magnet armature 17 of the magnetic valve is provided, too. Furthermore, an annular recess is to be seen, by which motor oil in the valve body 3 is also conducted into the guide of the valve needle 18, thus purifying this region from possible deposits and impurities contained in the heavy oil.

FIG. 5 depicts, in section, a valve body where the valve bush 23 is pressed in. Channels for supplying high-pressure fuel to the inlet throttle 15 and for draining fuel via the outlet throttle 20 to the valve seat 19 of the valve bush 23 are incorporated in the lower side of the valve body 3. On the cylindrical outer contour of the valve bush 23 are formed several surfaces which, together with grooves provided on the upper side of the valve bush 23, provide a connection from the outlet throttle 20 to the valve seat via at least one outlet channel 28 formed and delimited by the clearance flanks.

FIG. 6 is a sectional illustration of a valve body, depicting an annular branch duct 27 which enables leakage fuel ascending from the valve seat 19 and motor oil leaking from above along the valve needle 18 to be conducted into a pressureless outlet.

FIG. 7 is a sectional illustration through a valve body comprising a floating valve bush. Fuel guidance from the outlet throttle to the valve seat of the valve bush in this case is performed via a hollow-cylindrical space provided between the valve body and the floating valve bush 23.

1. A control valve for an injection nozzle for injecting fuels into the combustion chamber of an internal combustion engine, including a nozzle needle which is capable of being axially displaced in an injector nozzle and reaches into a control chamber feedable with a pressurized fuel whose pressure is controllable via the control valve, which opens or closes at least one inlet or outlet channel for fuel, characterized in that the valve seat of the valve is arranged in a valve bush separate from the valve body and made of a wear-resistant material.

2. A control valve according to claim 1, characterized in that said separate valve bush is floatingly mounted in a space of the valve body.

3. A control valve according to claim 1, characterized in that the valve bush on its cylindrical outer surfaces, or end faces, comprises grooves or chamfers forming channels leading to an outlet and/or inlet throttle for respectively letting fuels out of or into the control chamber.

4. A control valve according to claim 1, characterized in that the valve needle on its jacket carries grooves or flutes which cooperate with branch ducts leading to the jacket of the valve needle.

5. A control valve according to claim 2, characterized in that the valve bush on its cylindrical outer surfaces, or end faces, comprises grooves or chamfers forming channels leading to an outlet and/or inlet throttle for respectively letting fuels out of or into the control chamber.

6. A control valve according to claim 2, characterized in that the valve needle on its jacket carries grooves or flutes which cooperate with branch ducts leading to the jacket of the valve needle.

7. A control valve according to claim 3, characterized in that the valve needle on its jacket carries grooves or flutes which cooperate with branch ducts leading to the jacket of the valve needle.
